(19) United States
(12) Patent Application Publication
(10) Pub. No.: US 2015/0149057 A1
(43) Pub. Date: May 28, 2015

(54) SYSTEM AND METHOD FOR PROTECTING DRIVE SHAFT

(71) Applicant: Hyundai Motor Company, Seoul (KR)

(72) Inventors: Jaewan Cho, Uiwang (KR); Young Deok Won, Yongin (KR)

(73) Assignee: Hyundai Motor Company, Seoul (KR)

(21) Appl. No.: 14/091,930

(22) Filed: Nov. 27, 2013

(51) Int. Cl. B60K 28/16; B60W 30/02; B60W 10/06

(52) U.S. Cl. CPC B60K 28/16; B60W 10/06; B60W 30/02
USPC 701/84

(57) ABSTRACT

A system and method for protecting a drive shaft that include a vehicle state detector configured to detect vehicle information including currently selected shift speed, hydraulic pressure signal detected by a hydraulic pressure detector mounted to a hydraulic pressure power steering assembly, vehicle speed, and engine RPM. In addition, a traction controller is configured to analyze the vehicle information delivered from the vehicle state detector and request reduction of torque when a predetermined condition is satisfied. An engine controller is configured to reduce output torque of an engine based on torque reduction requested by the traction controller to cause the torque applied to the drive shaft to be less than a limit torque.

### CROSS-REFERENCE TO RELATED APPLICATION

This application claims priority to and the benefit of Korean Patent Application No. 10-2012-0145731 filed in the Korean Intellectual Property Office on Dec. 13, 2012, the entire contents of which are incorporated herein by reference.

### BACKGROUND

(a) Field of the Invention

The present invention relates to a system and a method that protect a drive shaft. More particularly, the present invention relates to a system and a method that protect a drive shaft which reduces output torque of an engine during reverse speed and a full turn and when a stall condition of a transmission is satisfied to prevent limit torque from being applied to the drive shaft.

(b) Description of the Related Art

Generally, when high torque of an engine is output when braking force is generated, secondary moment of driving torque is generated due to the braking force and an angle of a drive shaft (e.g., an angle between the drive shaft and a level surface). Reaction force is applied to suspension components due to the secondary moment of the driving torque, and such reaction force increases steering by compliance effect and thus increases the angle of the drive shaft.

Particularly, when a brake pedal and an accelerator pedal are simultaneously engaged to generate the braking force and the high engine output during the full turn and the reverse speed, the limit torque is applied to the drive shaft and noise is generated. In extreme cases, chassis may be deformed and the drive shaft and a joint may be damaged. Herein, the limit torque means torque which can plastically deform the drive shaft.

For example, a common angle of the drive shaft is set to about 46.5°, but the angle of the drive shaft is often greater than about 46.5° due to suspension geometry. Therefore, the drive shaft may be damaged during the stall of the transmission. Furthermore, the size of the joint may be increased to maintain strength in high angle of the drive shaft, and a stopper may be installed near a knuckle or a lower arm to prevent change to the suspension geometry. However, such methods increase cost and weight.

Additionally, to detect a steering angle during a full turn, a steering angle sensor may be required. However, the steering angle sensor may only mounted to a motor driven power steering (MDPS) not to a vehicle with a HPS (Hydraulic Power Steering).

The above information disclosed in this section is only for enhancement of understanding of the background of the invention and therefore it may contain information that does not form the prior art that is already known in this country to a person of ordinary skill in the art.

### SUMMARY

The present invention provides a system and a method that protect a drive shaft having advantages of protecting the drive shaft by reducing output torque of an engine when a current driving state may damage the drive shaft.

A system that protects a drive shaft according to an exemplary embodiment of the present invention may include a vehicle state detector that detects vehicle information including currently selected shift speed, hydraulic pressure signal detected by a hydraulic pressure detector mounted to a hydraulic pressure power steering assembly, vehicle speed and engine RPM (revolutions per minute), a traction controller that analyzes the vehicle information delivered from the vehicle state detector and requests reduction of torque when a predetermined condition is satisfied, and an engine controller that reduces output torque of an engine based on torque reduction requested by the traction controller to cause torque applied to the drive shaft to be less than limit torque.

The predetermined condition may be satisfied when the currently selected shift speed is a reverse speed, the hydraulic pressure signal of the hydraulic pressure detector is higher than predetermined pressure, and stall condition is satisfied. The stall condition may be satisfied when the vehicle speed is less than a predetermined speed and the engine RPM is greater than a predetermined RPM.

A method for protecting a drive shaft according to an exemplary embodiment of the present invention may include determining whether a currently selected shift speed is a reverse speed, determining whether hydraulic pressure applied to a hydraulic pressure power steering assembly is greater than a predetermined hydraulic pressure when the currently selected shift speed is the reverse speed, determining whether a stall condition is satisfied when the hydraulic pressure applied to the hydraulic pressure power steering assembly is greater than the predetermined hydraulic pressure, and controlling torque applied to the drive shaft to be less than a limit torque by reducing output torque of an engine when the stall condition is satisfied. The stall condition may be satisfied when the vehicle speed is less than a predetermined speed and the engine RPM is greater than a predetermined RPM.

According to an exemplary embodiment of the present invention, durability of a drive shaft may be improved by reducing output torque of an engine without changing a layout and characteristics of the vehicle. Therefore, cost may be curtailed. In addition, since static and dynamic characteristics of the vehicle are not changed and a structure of a power train is not changed, acceleration characteristics and turbo characteristics of the vehicle may be maintained. Therefore, marketability and stability of the vehicle may be improved. Since a general hydraulic pressure sensor may be applied to the present invention, a drive shaft may be protected without requiring a steering angle sensor.

### BRIEF DESCRIPTION OF THE DRAWINGS

FIG. 1 is an exemplary block diagram of a system that protects a drive shaft according to an exemplary embodiment of the present invention;

FIG. 2 is an exemplary flowchart of a method for protecting a drive shaft according to an exemplary embodiment of the present invention; and

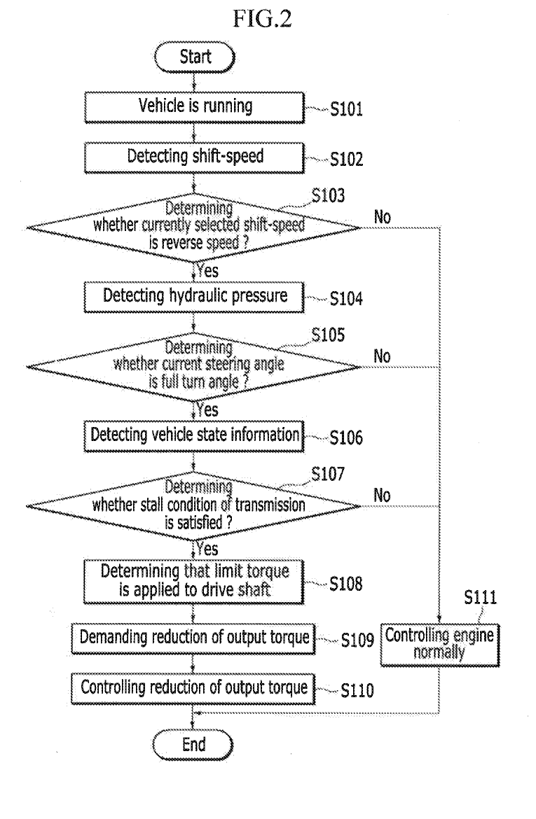

FIG. 3 is an exemplary graph showing hydraulic pressure and output of a hydraulic pressure sensor applied to a system that protects a drive shaft according to an exemplary embodiment of the present invention.

Description of symbols

| | |
|---|---|
| 11: shift-speed detector | 12: hydraulic pressure detector |
| 13: vehicle speed detector | 14: RPM detector |
| 20: traction controller | 30: engine controller |

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Additionally, it is understood that the term controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”

Hereinafter, referring to the drawings, exemplary embodiments of the present invention will be described in detail.

As those skilled in the art would realize, the described embodiments may be modified in various different ways, all without departing from the spirit or scope of the present invention. Description of components that are not necessary for explaining the present invention will be omitted, and the same constituent elements are denoted by the same reference numerals in this specification.

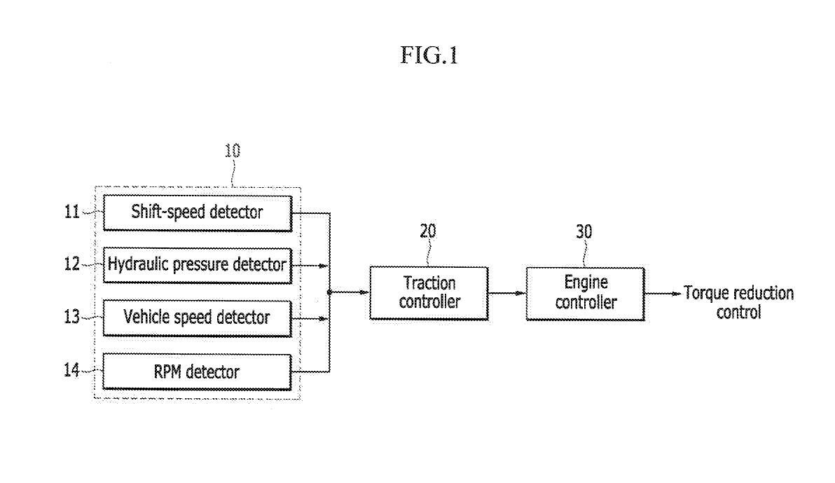

FIG. 1 is an exemplary block diagram of a system that protects a drive shaft according to an exemplary embodiment of the present invention. As shown in FIG. 1, a system that protects a drive shaft according to an exemplary embodiment of the present invention may include a vehicle state detector 10, a traction controller 20, and an engine controller 30.

The vehicle state detector 10 may be configured to detect shift speed information which is a position of a shift lever, steering angle information from a steering wheel, vehicle speed information, engine RPM information, and may be configured to transmit the information to the traction controller 20. In other words, the vehicle state detector 10 may include a shift speed detector 11 configured to detect shift speed which is selected by the shift lever, a hydraulic pressure detector 12 mounted to a hydraulic pressure power steering assembly and configured to detect hydraulic pressure within the power steering assembly, a vehicle speed detector 13 configured to detect vehicle speed from rotation speed of an output shaft of a transmission or rotation speed of a wheel, and an RPM detector 14 that may include a crank angle sensor or a cam angle sensor and may be configured to detect rotation speed of the engine.

A steering angle sensor may be omitted from a vehicle with hydraulic pressure type power steering (HPS). However the hydraulic pressure detector 12 may be configured to detect hydraulic pressure within the hydraulic pressure power steering assembly (e.g., operated hydraulic pressure of the hydraulic pressure power steering assembly).

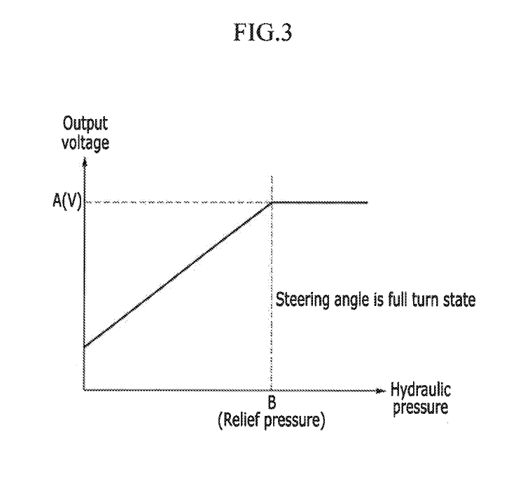

FIG. 3 is an exemplary graph showing hydraulic pressure and output of a hydraulic pressure sensor applied to a system that protects a drive shaft according to an exemplary embodiment of the present invention. The hydraulic pressure detector 12, that is a hydraulic pressure sensor, may be configured to prevent idle booming or engine shut off when a steering wheel is steered in idle state.

In particular, hydraulic pressure may be used as assist power sources when steering the steering wheel, and the hydraulic pressure may be generated by the engine. However, in an idle state, engine RPM is lowered, and booming or engine shut off may occur. To prevent booming or engine shut off, in the vehicle with the hydraulic pressure type power steering, the engine RPM may be compensated by detecting hydraulic pressure.

Referring to FIG. 3, when the signal (e.g., output voltage) output from the hydraulic pressure sensor reaches a predetermined value A, the output may be interpreted as the hydraulic pressure being equal to or greater than a predetermined pressure (e.g., B; relief pressure). In addition, the output may be interpreted as a maximum steering angle, or that the steering angle is a full turn angle.

The traction controller 20 may be configured to analyze the information transmitted from the vehicle state detector 10 and request torque reduction from the engine controller 30 when a predetermined condition is satisfied. The predetermined condition may be satisfied when the currently selected shift speed is a reverse speed, the hydraulic pressure signal of the hydraulic pressure detector 12 is greater than the predetermined pressure, and a stall condition is satisfied.

Therefore, the torque applied to the drive shaft may be reduced via torque reduction execution by the engine controller 30 and the drive shaft may be stably protected.

The stall of the transmission may occur when the torque of the engine is input to a torque converter but rotation speed of a turbine is about zero. The stall condition of the transmission may be represented by a function of engine variables and transmission variables that may generate the stall. For example, the stall condition of the transmission may be defined as a function of variables such as the engine RPM, the vehicle speed, power delivery ratio of the torque converter, RPM of the torque converter, ratios of torque of the engine and the transmission, ratio of speed of the engine and the transmission, and the like. The stall condition of the transmission may be satisfied when the vehicle speed is less than a predetermined speed, e.g., about 2 km/h by engagement of the brake pedal and the engine RPM is greater than a predetermined RPM, e.g., about 2000 RPM by engagement of the accelerator pedal.

The engine controller 30 may be configured to reduce the output torque of the engine by a predetermined amount based on the torque reduction demand of traction controller 20 connected by network and may be configured to prevent the limit torque from being applied to the drive shaft. Further, reduction of the output torque of the engine may be performed by lagging ignition timing or reducing fuel injection amount.

The traction controller 20 and the engine controller 30 may be provided separately as described herein above, but the traction controller 20 and the engine controller 30 are not limited to configuration. In other words, the traction controller 20 and the engine controller 30 may be combined as one controller.

Hereinafter, a method for protecting a drive shaft according to an exemplary embodiment of the present invention will be described in detail.

When the vehicle to which an exemplary embodiment of the present invention is applied is running at a step S101, the shift speed detector 11 may be configured to detect the shift speed selected by the shift lever at a step S102. Further, the traction controller 20 may be configured to determine whether the currently selected shift speed is the reverse speed at a step S103.

When the currently selected shift speed is not the reverse speed at the step S103, the traction controller 20 may be configured to request the engine controller 30 to operate the engine normally at a step S111. Accordingly, the engine controller 30 may be configured to operate the engine to output the torque according to current driving condition at the step S111. In this specification, the normal control of the engine does not use an exemplary embodiment of the present invention and operates the engine to output the torque according to the current driving condition.

When the currently selected shift speed is the reverse speed at the step S103, the hydraulic pressure detector 12 may be configured to detect the hydraulic pressure within the hydraulic pressure power steering assembly at a step S104, and the traction controller 20 may be configured to determine whether the current steering angle is the full turn angle of the steering wheel at a step S105 using the detected hydraulic pressure. The full turn angle of the steering wheel may be the detected current hydraulic pressure greater than the predetermined hydraulic pressure, and may be set according to necessary performance.

When the detected current hydraulic pressure less than the predetermined hydraulic pressure at the step S105, the traction controller 20 may be configured to request the engine controller 30 to operate the engine normally, and the engine controller 20 may be configured to operate the engine to output the torque according to the current driving condition at the step S111.

When the detected hydraulic pressure, however, is greater than the predetermined hydraulic pressure at the step S105, the vehicle state information including the vehicle speed, the engine RPM, the position of the accelerator pedal, and whether the brake pedal is operated may be detected at a step S106. Further, the traction controller 20 may be configured to analyze the vehicle state information and determine whether the stall condition of the transmission is satisfied at a step S107.

The stall condition of the transmission may be satisfied when the vehicle speed is less than a predetermined speed, e.g., about 2 km/h by engagement of the brake pedal and the engine RPM is greater than a predetermined RPM, e.g., about 2000 RPM by engagement of the accelerator pedal. However, the vehicle speed (i.e., about 2 km/h) and the engine RPM (i.e., about 2000 RPM) may be set according to the necessary performance.

When the stall condition of the transmission is not satisfied at the step S107, the traction controller 20 may be configured to request the engine controller 30 to operate the engine normally, and the engine controller 20 may be configured to operate the engine to output the torque according to the current driving condition at the step S111.

When the stall condition of the transmission is satisfied at the step S107, the traction controller 20 may be configured to determine that the limit torque is applied to the drive shaft at a step S108. Therefore, the traction controller 20 may be configured to request the engine controller 20 to reduce the output torque to prevent the limit torque from being applied to the drive shaft at a step S109.

The engine controller 30 may be configured to reduce the output torque of the engine by the predetermined amount based on the torque reduction request and operate the torque applied to the drive shaft to be less than the limit torque at a step S110. Therefore, the damage of the drive shaft may be prevented.

According to an exemplary embodiment of the present invention, durability of a drive shaft may be improved by reducing output torque of an engine without changing a layout and characteristics of the vehicle. Therefore, cost may be curtailed. In addition, since static and dynamic characteristics of the vehicle are not changed and a structure of a power train is not changed, acceleration characteristics and turbo characteristics of the vehicle may be maintained. Therefore, marketability and stability of the vehicle may be improved. Since a general hydraulic pressure sensor may be applied to the present invention, a drive shaft may be protected without the need for a steering angle sensor.

While this invention has been described in connection with what is presently considered to be exemplary embodiments, it is to be understood that the invention is not limited to the disclosed embodiments. On the contrary, it is intended to cover various modifications and equivalent arrangements included within the spirit and scope of the accompanying claims.

What is claimed is:

1. A system that protects a drive shaft, comprising:
a vehicle state detector configured to detect vehicle information including currently selected shift speed, hydraulic pressure signal detected by a hydraulic pressure detector mounted to a hydraulic pressure power steering assembly, vehicle speed, and engine RPM (revolutions per minute);
a traction controller configured to analyze the vehicle information delivered from the vehicle state detector and request reduction of torque when a predetermined condition is satisfied; and
an engine controller configured to reduce output torque of an engine based on torque reduction requested by the traction controller to cause torque applied to the drive shaft to be less than a limit torque.

2. The system of claim 1, wherein the predetermined condition is satisfied when the currently selected shift speed is a reverse speed, the hydraulic pressure signal of the hydraulic pressure detector is greater than a predetermined pressure, and a stall condition is satisfied.

3. The system of claim 2, wherein the stall condition is satisfied when the vehicle speed is less than a predetermined speed and the engine RPM is greater than a predetermined RPM.

4. The system of claim 2, wherein the stall condition is satisfied when the vehicle speed is less than about 2 km/h by engagement of the brake pedal and the engine RPM is greater than about 2000 RPM by engagement of the accelerator pedal.

5. A method for protecting a drive shaft, comprising:
determining, by a traction controller, whether a currently selected shift speed is a reverse speed;
determining, by the traction controller, whether hydraulic pressure applied to a hydraulic pressure power steering assembly is greater than a predetermined hydraulic pressure when the currently selected shift speed is the reverse speed;
determining, by the traction controller, whether a stall condition is satisfied when the hydraulic pressure applied to the hydraulic pressure power steering assembly is greater than the predetermined hydraulic pressure; and
controlling, by an engine controller, torque applied to the drive shaft to be less than a limit torque by reducing output torque of an engine when the stall condition is satisfied.

6. The method of claim 5, wherein the stall condition is satisfied when the vehicle speed is less than a predetermined speed and the engine RPM (revolutions per minute) is greater than a predetermined RPM.

7. The system of claim 5, wherein the stall condition is satisfied when the vehicle speed is less than about 2 km/h by engagement of the brake pedal and the engine RPM is greater than about 2000 RPM by engagement of the accelerator pedal.
